(19) United States
(12) Patent Application Publication
(10) Pub. No.: US 2024/0127037 A1
(43) Pub. Date: Apr. 18, 2024

(54) Method And Apparatus For Training Artificial Intelligence/Machine Learning Models

(71) Applicant: MediaTek Inc., Hsinchu City (TW)

(72) Inventors: Pedram Kheirkhah Sangdeh, San Jose, CA (US); Gyu Bum Kyung, San Jose, CA (US)

(21) Appl. No.: 18/372,664

(22) Filed: Sep. 25, 2023

Related U.S. Application Data
(60) Provisional application No. 63/379,327, filed on Oct. 13, 2022.

(51) Int. Cl. G06N 3/0455; H04W 16/22

(52) U.S. Cl. CPC G06N 3/0455; H04W 16/22

(57) ABSTRACT

Techniques pertaining to training artificial intelligence (AI)/machine learning (ML) models in wireless communications are described. An apparatus participates in training of a two-sided AI/ML model. The apparatus also performs a wireless communication by utilizing the two-sided AI/ML model.

### CROSS REFERENCE TO RELATED PATENT APPLICATION(S)

The present disclosure is part of a non-provisional application claiming the priority benefit of U.S. Patent Application No. 63/379,327, filed 13 Oct. 2022, the content of which herein being incorporated by reference in its entirety.

### TECHNICAL FIELD

The present disclosure is generally related to wireless communications and, more particularly, to training artificial intelligence (AI) and machine learning (ML) models in wireless communications.

### BACKGROUND

Unless otherwise indicated herein, approaches described in this section are not prior art to the claims listed below and are not admitted as prior art by inclusion in this section.

In a communication system, such as wireless communications in accordance with the 3^{rd} Generation Partnership Project (3GPP) standards, many functions on the user equipment (UE) side tend to have a corresponding twin on the network side, and vice versa. In the context of AI/ML, this may be referred to as a two-sided AI/ML model, also known as autoencoders. For example, for a modulation function at the UE/network there is a demodulation function at the network/UE, for a quantization function at the UE/network there is a dequantization function at the network/UE, for a forward error correction (FEC) encoder at the UE/network there is a decoder at the network/UE, and for a signal shaper function at the UE/network there is a de-shaper at the network/UE, and vice versa. There are also functions/applications that need complimentary modules at both the UE and network such as, for example, image compression, channel state information (CSI) compression, and peak-to-average-power ratio (PAPR) reduction. In short, in a two-sided AI/ML model, it is most ideal to training both sides together so that the function on one side is compatible with the corresponding function on the other side.

With respect to training of AI/ML models in wireless communication systems, there may be several training stages at a single entity (e.g., the UE or a network node of the network). Initially, a desired architecture of encoder and decoder for two-sided AI/ML models need to be designed. Then, both sides need to be trained through a forward pass (FP) and backpropagation (BP). In FP, the encoder passes encoded information (e.g., latent vector) to the decoder, and the decoder recovers the information. In BP, reconstruction error is calculated and its gradient with respect to parameters may propagate through the encoder and decoder for updates to the parameters. Lastly, performance of the two-sided AI/ML model as a whole needs to be verified.

In a multi-vendor wireless ecosystem in which UEs and network nodes may be manufactured and provided by different vendors, a UE vendor may leverage encoders/decoders of the vendor's exclusive AI/ML model at the deployment stage. Similarly, a network vendor may leverage decoders/encoders of that vendor's exclusive AI/ML model. In such a multi-vendor wireless ecosystem, the deployment would work if and only if certain conditions are met, namely: (1) an encoder has already learned to provide interpretable information for decoders; and (2) a decoder has already learned to interpret information from encoders. However, there is an issue regarding how the encoders and decoders could learn. Therefore, there is a need for a solution of training AI/ML models in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to training AI/ML models in wireless communications. It is believed that implementations of the various proposed schemes may address or otherwise alleviate the aforementioned issue(s).

In one aspect, a method may involve an apparatus participating in training of a two-sided AI/ML model. The method may also involve the apparatus performing a wireless communication by utilizing the two-sided AI/ML model.

In yet another aspect, an apparatus may include a transceiver configured to communicate wirelessly and a processor coupled to the transceiver. The processor may participate in training of a two-sided AI/ML model. The processor may also perform a wireless communication by utilizing the two-sided AI/ML model.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of example scenarios in accordance with an implementation of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a diagram of an example scenario in accordance with an implementation of the present disclosure.

FIG. 9 is a diagram of an example scenario in accordance with an implementation of the present disclosure.

FIG. 10 is a diagram of an example scenario in accordance with an implementation of the present disclosure.

FIG. 11 is a block diagram of an example communication system in accordance with an implementation of the present disclosure.

FIG. 12 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to training AI/ML models in wireless communications. According to the present disclosure, a number of possible solutions may be implemented separately or jointly. That is, although these possible solutions may be described below separately, two or more of these possible solutions may be implemented in one combination or another.

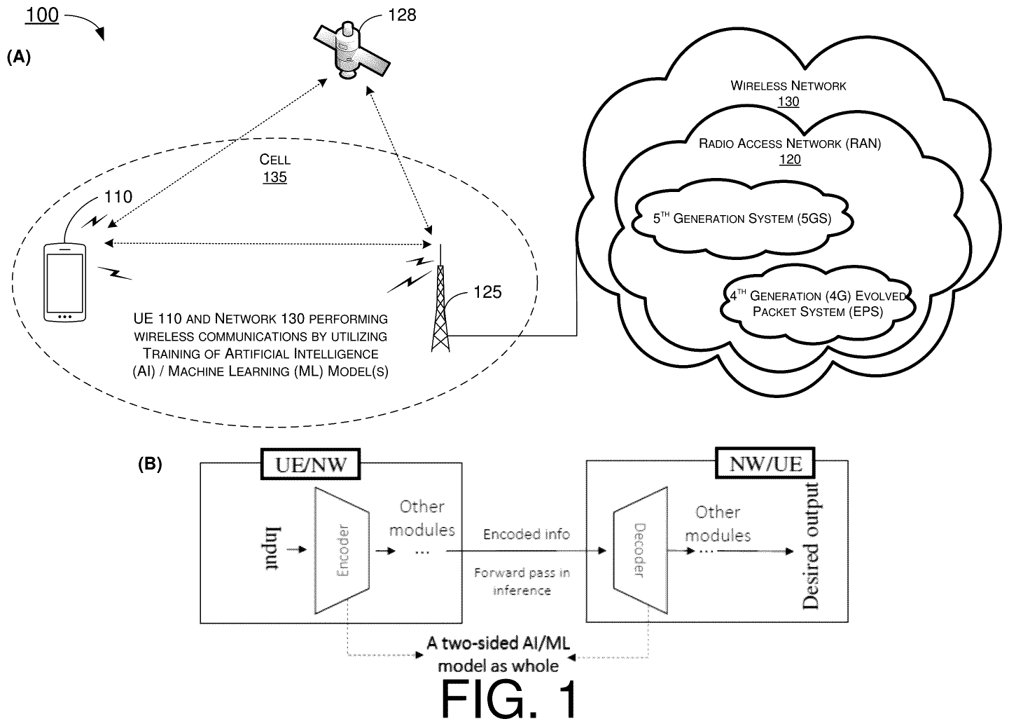

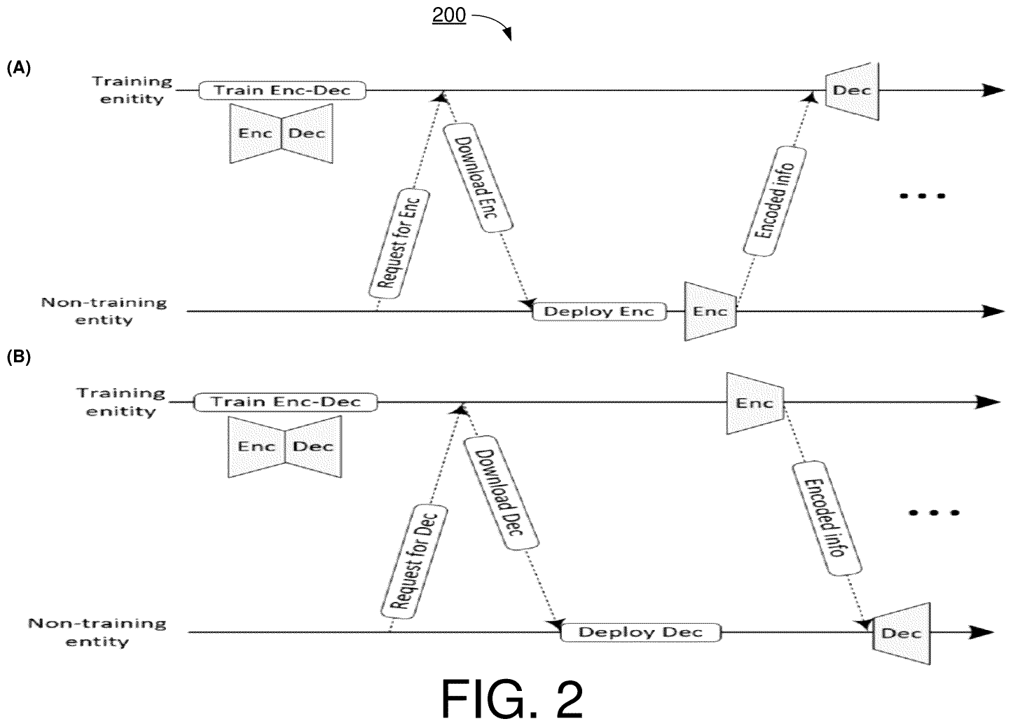

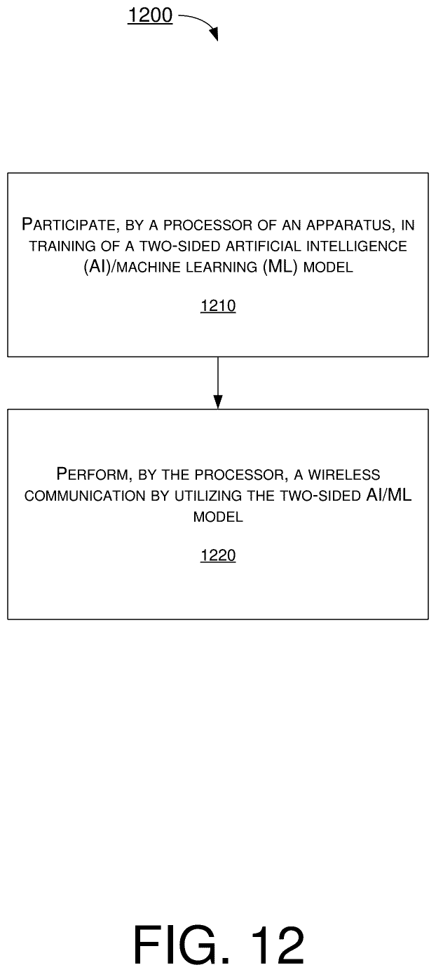

FIG. 1 illustrates an example network environment 100 in which various solutions and schemes in accordance with the present disclosure may be implemented. FIG. 2˜FIG. 12 illustrate examples of implementation of various proposed schemes in network environment 100 in accordance with the present disclosure. The following description of various proposed schemes is provided with reference to FIG. 1˜FIG. 12.

Referring to part (A) of FIG. 1, network environment 100 may involve a UE 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a network 130. In network environment 100, UE 110 and network 130 (via terrestrial network node 125 and/or non-terrestrial network node 128) may implement various schemes pertaining to training AI/ML models in wireless communications, as described below. Part (B) of FIG. 1 shows an example of a two-sided AI/ML model as a whole implemented at a UE, such as UE 110, and a network (NW), such as terrestrial network node 125 and/or non-terrestrial network node 128. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under various proposed schemes in accordance with the present disclosure with respect to training strategies for training AI/ML models, there are certain design aspects to be considered. One aspect is performance, which requires high re-construction accuracy and low overhead encoded information (which may be applicable to some applications such as image and CSI compression). Another aspect is training requirements. For instance, there may be low signaling requirements for downloading and registering AI/ML models. There may also be requirements on limited information exchange between two vendors to train an autoencoder, limited number of training sessions between multiple vendors, and less alignment between vendors (e.g., synchronization, dataset distribution and size, scenarios, configuration, and so on). A further aspect is proprietary nature in that vendors' proprietary encoder/decoder architecture, training-related standalone techniques, as well as hyperparameters may need to be maintained.

Accordingly, there may be different types of training under the proposed schemes, namely: Training Type I, Training Type II and Training Type III. That is, there is no universal solution to meet all design objectives. In Training Type I, training of an exclusive design of an autoencoder (including an encoder and a decoder) on a single entity may be performed. In Training Type II, a joint training of encoder(s) and decoder(s) at different entities may be performed. In Training Type III, sequential separate trainings of encoder(s) and decoder(s) at different entities may be performed. For instance, in an encoder-first training under Training Type III, encoder(s) of UE/network vendor(s) may be trained first, and then decoder(s) of network/UE vendor(s) may learn how to work with the trained encoder(s). Conversely, in a decoder-first training under Training Type III, decoder(s) of UE/network vendor(s) may be trained first, and then encoder(s) of network/UE vendor(s) may learn how to work with the trained decoder(s).

FIG. 2 illustrates an example scenario 200 under a proposed scheme with respect to Training Type I in accordance with the present disclosure. Under the proposed scheme, a Training Type I may be performed as a joint training at a single entity with model transfer. For instance, at a training stage, a training entity (e.g., UE or network node) may train its exclusive (matched) two-sided AI/ML model(s) in a single training session and through individual FP and BP loops. Moreover, at an inference stage, a non-training entity may request the training entity to provide its corresponding part (encoder or decoder). Also, the non-training entity may download its corresponding part of the two-sided AI/ML model. Part (A) of FIG. 2 shows an example of a training entity providing a model of an encoder to a non-training entity. Part (B) of FIG. 2 shows an example of a training entity providing a model of a decoder to a non-training entity.

There may be some advantages and disadvantages associated with Training Type I. In terms of advantages associated with Training Type I, there may be performance guarantee. That is, as the encoder and decoder belong to the same exclusive/matched design, the two-sided model may achieve optimal performance. Another advantage may pertain to easier monitoring and lifecycle management. That is, one entity may monitor, modify and retrain the entire two-sided AI/ML model. On the other hand, in terms of disadvantages associated with Training Type I, there may be training and maintenance burden of AI/ML model on the single entity. Moreover, there tends to be large signaling overhead for downloading AI/ML models for extreme scenarios with fast transitions between cells, regions, scenarios, configurations, and so forth.

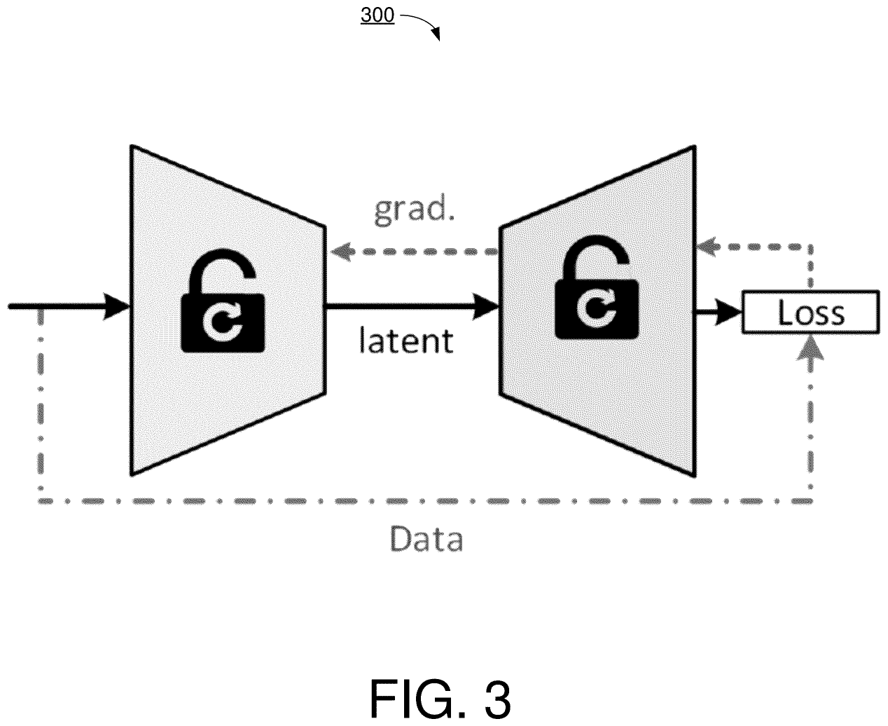

FIG. 3 illustrates an example scenario 300 under a proposed scheme with respect to Training Type II in accordance with the present disclosure. Under the proposed scheme, a Training Type II may be performed as a joint training without model transfer. For instance, with respect to a training procedure, both UE 110 and network 130 may be synchronized at a sample level. That is, an encoder may share encoded information (latent vector) in forward pass (FP) and a decoder may share gradient on its input layer in backpropagation (BP). Under the proposed scheme, implementation of Training Type II may require a shared dataset, a gradient exchange, and a latent output exchange. There may be some advantages and disadvantages associated with Training Type II. In terms of advantages, high performance for unmatched architectures of encoder(s) and decoder(s) may be achieved under Training Type II. As for disadvantages, Training Type II requires sample-level synchronization, and there tends to be frequent and large-overhead information exchange under Training Type II.

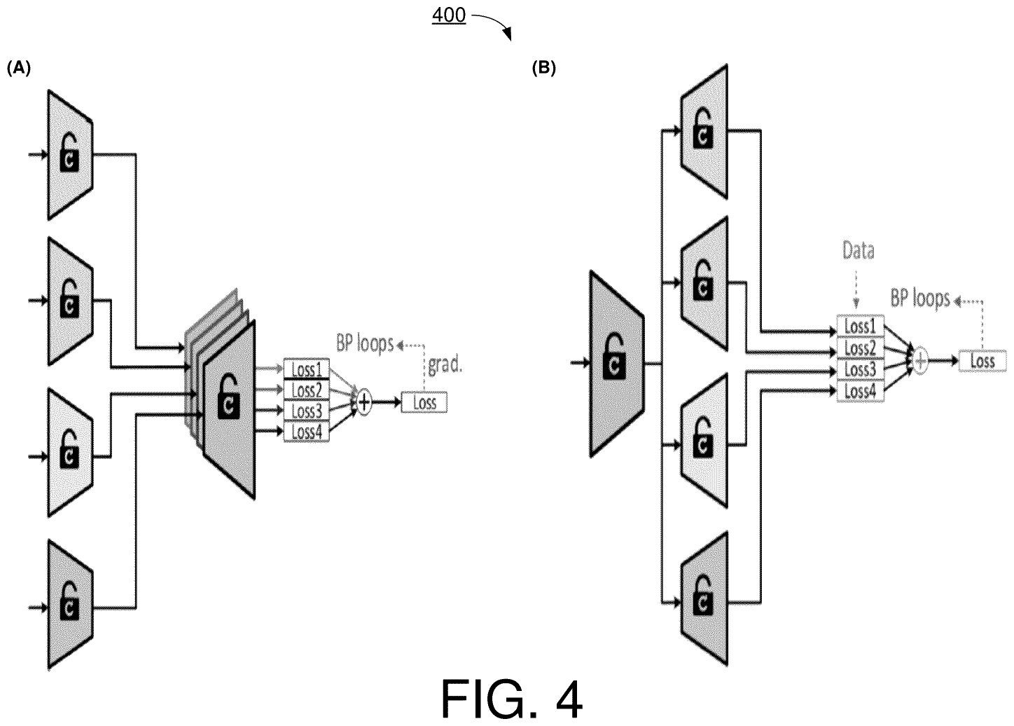

FIG. 4 illustrates an example scenario 400 under a proposed scheme in accordance with the present disclosure. Scenario 400 may pertain to an extension of Training Type I to training of multiple encoders and multiple decoders. Referring to part (A) of FIG. 4, in a multi-encoder-and-single-decoder deployment, multiple encoders may share latent vector(s) in FP, and each decoder of one or more decoders may share gradient(s) in BP. Referring to part (B) of FIG. 4, in a single-encoder-and-multi-decoder deployment, each encoder of one or more encoders may share latent vector(s) in FP, and multiple decoders may share gradient(s) in BP.

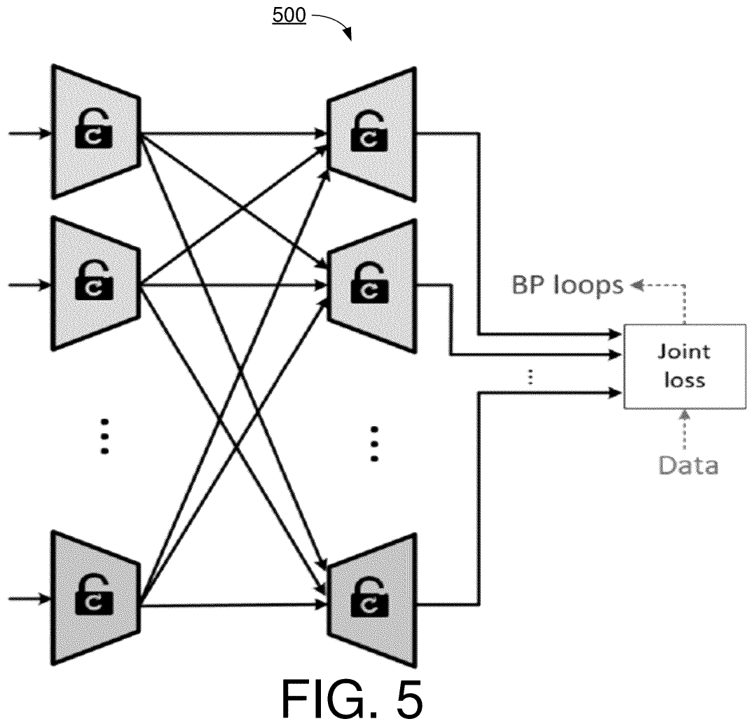

FIG. 5 illustrates an example scenario 500 under a proposed scheme in accordance with the present disclosure. Scenario 500 may pertain to another extension of Training Type I to training of multiple encoders and multiple decoders. Referring to FIG. 5, in a multi-encoder-and-multi-decoder deployment, multiple encoders may share latent vectors in FP and multiple decoders may share gradients in BP. Moreover, encoder-decoder pairs may use or not use the same dataset for training.

Referring to FIG. 3˜FIG. 5, there may nevertheless be some challenges to Training Type II. For instance, there may be imminent loss in performance for unmatched encoder-decoder pair(s). Additionally, there may need to be alignment on the input and output of the network such as datasets (e.g., size, distribution, underlying scenario/configuration, and so forth). Moreover, there may be possible bias toward matched encoder-decoder pair(s) at least architecture-wise.

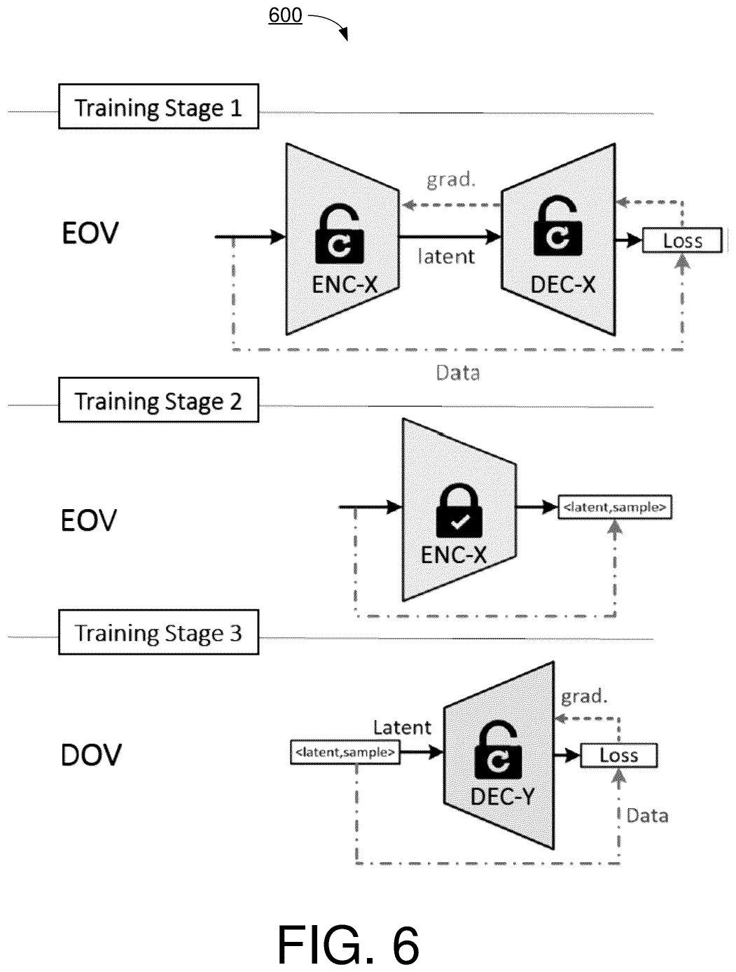

FIG. 6 illustrates an example scenario 600 under a proposed scheme with respect to one aspect of Training Type III in accordance with the present disclosure. Under the proposed scheme, sequential separate training(s) under Training Type III may be performed or otherwise carried out in an encoder-first manner, as shown in FIG. 6. With encoder-first sequential separate training, an entity that uses an encoder in inference (e.g., encoder-owner vender (EOV)) may train its matched encoder-decoder pair and provide <latent, sample> dataset (e.g., as a compound dataset). In the present disclosure, “sample” refers to the input to an encoder, and “latent” refers to the output of the encoder. Moreover, an entity that uses a decoder in inference (e.g., decoder-owner vendor (DOV)) may train a decoder with the <latent, sample> dataset. Each of EOV and DOV may be either a network node or UE. Under the proposed scheme, shared dataset and encoded information (latent vector) from EOV may be required in implementing the encoder-first sequential separate training of Training Type III.

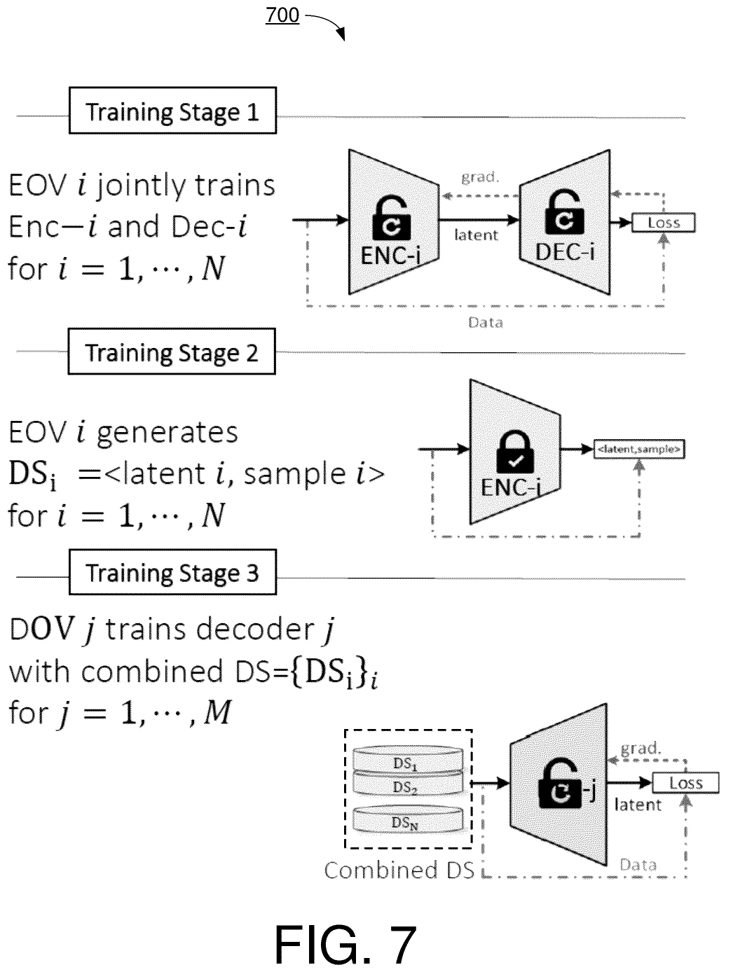

FIG. 7 illustrates an example scenario 700 under a proposed scheme with respect to another aspect of Training Type III in accordance with the present disclosure. Under the proposed scheme, the encoder-first sequential separate training may be extended to a multi-encoder-and-multi-decoder deployment with N EOVs and M DOVs (N>1 and M>1). In the training stages, each EOV of the N EOVs may train its two-sided model and each DOV of the M DOVs may receive a combined dataset DS={DSⱼ}ᵢ. For instance, EOV i may provide DSⱼ=<latent i, sample i> dataset, and DOV j may train decoder j with DS. There may be advantages and disadvantages associated with this approach. In terms of advantages, there may be one-time information exchange and relaxed synchronization requirement, and proprietariness may be maintained. In terms of disadvantages, there may be large loss in performance in an event that DOVs' decoders may fail to learn mapping of EOVs' encoders, and there may be a need to identify such vulnerable cases and design a fallback mechanism before deployment.

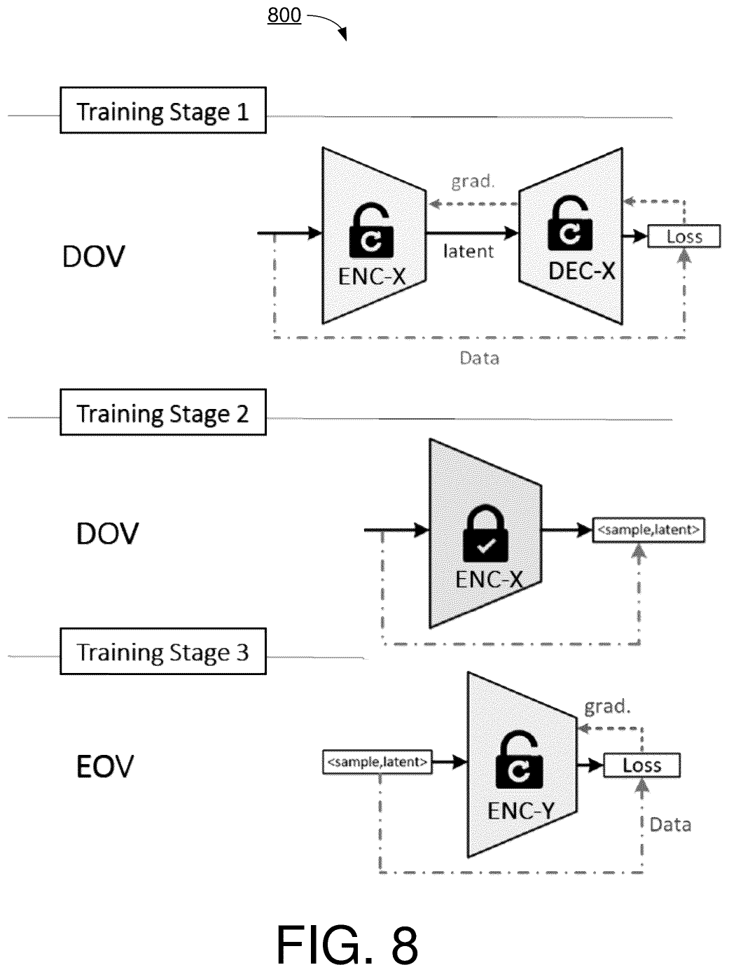

FIG. 8 illustrates an example scenario 800 under a proposed scheme with respect to one aspect of Training Type III in accordance with the present disclosure. Under the proposed scheme, sequential separate training(s) under Training Type III may be performed or otherwise carried out in a decoder-first manner, as shown in FIG. 8. With decoder-first sequential separate training, a DOV may train its matched pair of encoder-decoder and provide <sample, latent> dataset with its encoder. Moreover, an EOV may train an encoder with <sample, latent> dataset. Each of EOV and DOV may be either a network node or UE. Under the proposed scheme, shared dataset and encoded information (latent vector) from DOV may be required in implementing the decoder-first sequential separate training of Training Type III.

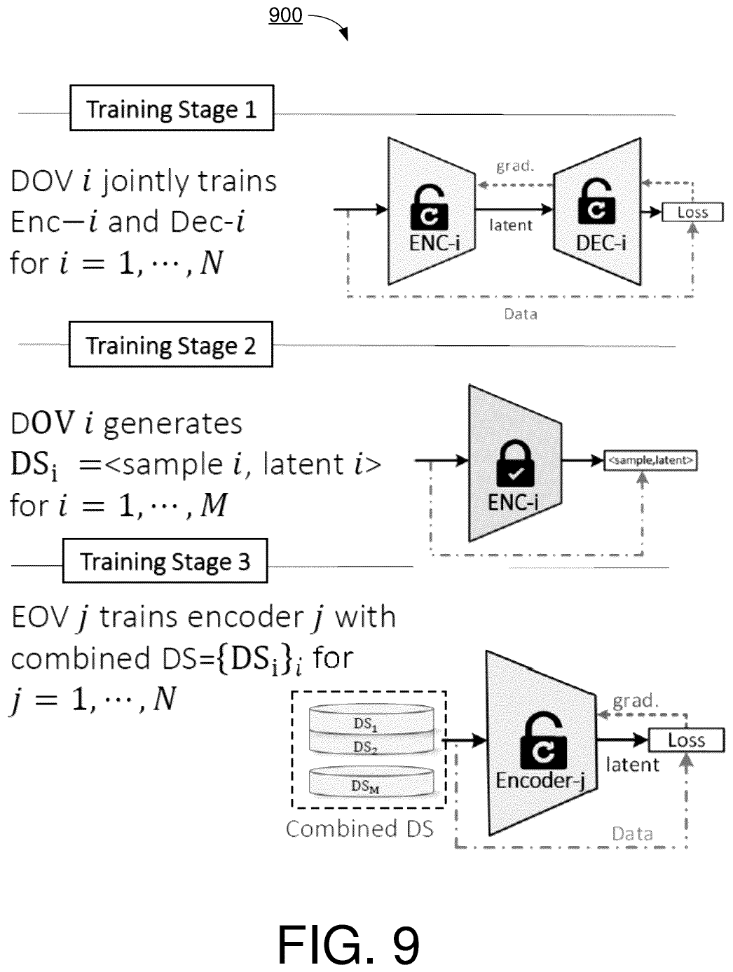

FIG. 9 illustrates an example scenario 900 under a proposed scheme with respect to another aspect of Training Type III in accordance with the present disclosure. Under the proposed scheme, the decoder-first sequential separate training may be extended to a multi-encoder-and-multi-decoder deployment with M DOVs and N EOVs (N>1 and M>1). In the training stages, each DOV of the M DOVs may train its two-sided model and each EOV of the N EOVs may receive a combined dataset DS={DSⱼ}ᵢ. For instance, DOV i may provide DSⱼ=<latent i, sample i> dataset, and EOV j may train encoder j with DS. There may be advantages and disadvantages associated with this approach. In terms of advantages, low training overhead may be achieved and no synchronization is necessary. In terms of disadvantages, performance under this approach may be inferior among all training types.

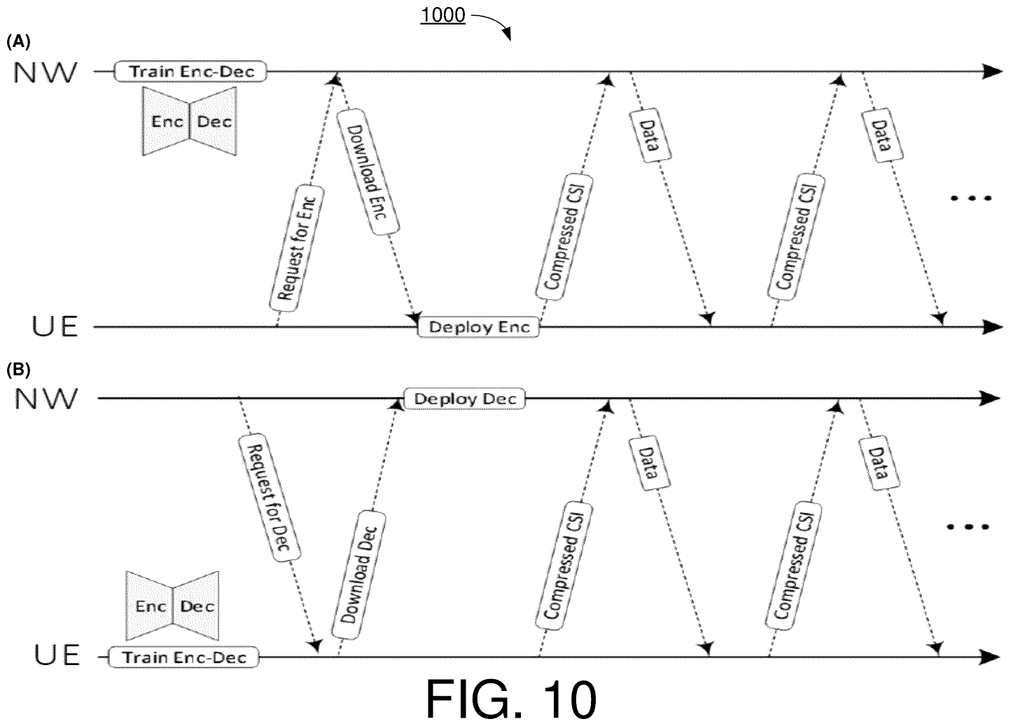

FIG. 10 illustrates an example scenario 1000 under a proposed scheme in accordance with the present disclosure. Scenario 1000 may pertain to an example of Training Type I for CSI compression. Part (A) of FIG. 10 shows an example of network (NW) training of CSI compression using Training Type I, and part (B) of FIG. 10 shows an example of UE training of CSI compression using Training Type I.

### Illustrative Implementations

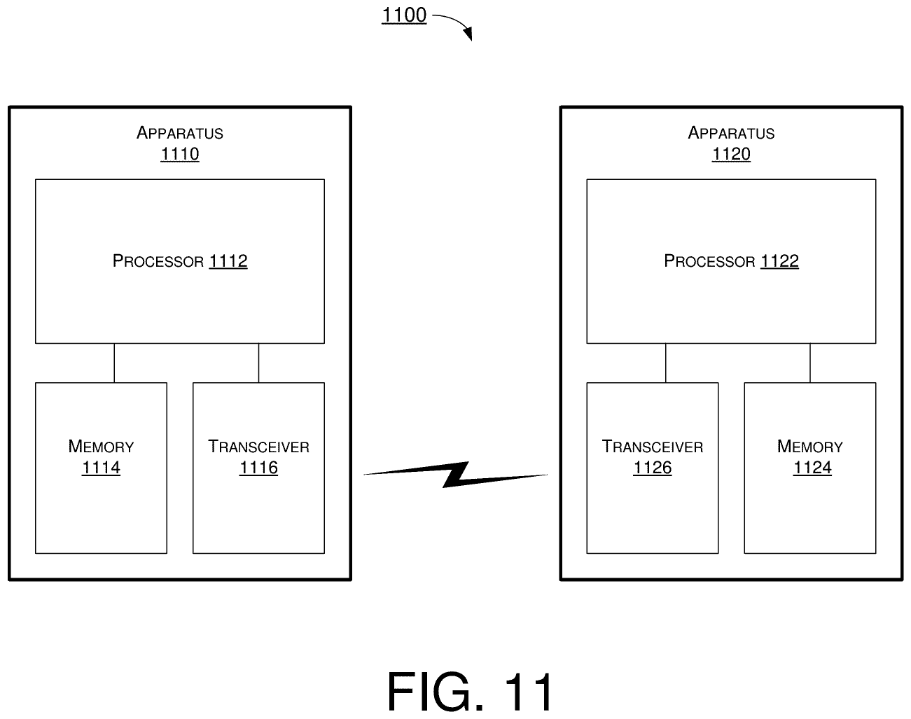

FIG. 11 illustrates an example communication system 1100 having at least an example apparatus 1110 and an example apparatus 1120 in accordance with an implementation of the present disclosure. Each of apparatus 1110 and apparatus 1120 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 1110 and apparatus 1120 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1110 and apparatus 1120 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 1110 and apparatus 1120 may be implemented in a smart thermostat, a smart fridge, a smart door lock, a wireless speaker or a home control center.

When implemented in or as a network apparatus, apparatus 1110 and/or apparatus 1120 may be implemented in an eNodeB in an LTE, LTE-Advanced or LTE-Advanced Pro network or in a gNB or TRP in a 5G network, an NR network or an IoT network.

In some implementations, each of apparatus 1110 and apparatus 1120 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1110 and apparatus 1120 may be implemented in or as a network apparatus or a UE. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC or RISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to training AI/ML models in wireless communications in accordance with various implementations of the present disclosure.

In some implementations, apparatus 1110 may also include a transceiver 1116 coupled to processor 1112. Transceiver 1116 may be capable of wirelessly transmitting and receiving data. In some implementations, transceiver 1116 may be capable of wirelessly communicating with different types of wireless networks of different radio access technologies (RATs). In some implementations, transceiver 1116 may be equipped with a plurality of antenna ports (not shown) such as, for example, four antenna ports. That is, transceiver 1116 may be equipped with multiple transmit antennas and multiple receive antennas for multiple-input multiple-output (MIMO) wireless communications. In some implementations, apparatus 1120 may also include a transceiver 1126 coupled to processor 1122. Transceiver 1126 may include a transceiver capable of wirelessly transmitting and receiving data. In some implementations, transceiver 1126 may be capable of wirelessly communicating with different types of UEs/wireless networks of different RATs. In some implementations, transceiver 1126 may be equipped with a plurality of antenna ports (not shown) such as, for example, four antenna ports. That is, transceiver 1126 may be equipped with multiple transmit antennas and multiple receive antennas for MIMO wireless communications.

In some implementations, apparatus 1110 may further include a memory 1114 coupled to processor 1112 and capable of being accessed by processor 1112 and storing data therein. In some implementations, apparatus 1120 may further include a memory 1124 coupled to processor 422 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110, as a UE (e.g., UE 110), and apparatus 1120, as a network node (e.g., network node 125) of a network (e.g., network 130 as a 5G/NR mobile network), is provided below in the context of example process 1200.

### Illustrative Processes

FIG. 12 illustrates an example process 1200 in accordance with an implementation of the present disclosure. Process 1200 may represent an aspect of implementing various proposed designs, concepts, schemes, systems and methods described above pertaining to training AI/ML models in wireless communications, whether partially or entirely, including those pertaining to those described above. Process 1200 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 1200 may be implemented by or in apparatus 1110 and/or apparatus 1120 as well as any variations thereof. Solely for illustrative purposes and without limiting the scope, each process is described below in the context of apparatus 1110 as a UE (e.g., UE 110) and apparatus 1120 as a communication entity such as a network node or base station (e.g., terrestrial network node 120) of a network (e.g., a 5G/NR mobile network). Process 1200 may begin at block 1210.

At 1210, process 1200 may involve processor 1112 of apparatus 1110 (e.g., as UE 110) participating in training of a two-sided AI/ML model (e.g., alone or together with apparatus 1120 as terrestrial network node 125 or non-terrestrial network node 128). Process 1200 may proceed from 1210 to 1220.

At 1220, process 1200 may involve processor 1112 performing, via transceiver 1116, a wireless communication by utilizing the two-sided AI/ML model.

In some implementations, in participating in training of the two-sided AI/ML model, process 1200 may involve processor 1112 participating in: (1) a first type of training involving training of an autoencoder at a single entity; or (2) a second type of training involving joint training of one or more encoders and one or more decoders at different entities; or (3) a third type of training involving a sequence of separate trainings of the one or more encoders and the one or more decoders at the different entities.

In some implementations, the first type of training may include a training stage in which the apparatus, as a training entity, trains a matched two-sided AI/ML model in a single training session and through individual FP and BP loops. In some implementations, the first type of training may further include an inference stage in which a non-training entity requests the training entity to provide corresponding encoder and decoder models and downloads a corresponding part of the two-sided AI/ML model.

In some implementations, the second type of training may include a training stage in which an encoder shares encoded information in a FP and a decoder shares gradient in a BP. In some implementations, the second type of training may involve apparatus 1110, as a training entity, and a non-training entity (e.g., apparatus 1120) being synchronized and sharing a shared dataset and performing gradient exchange and latent output exchange.

In some implementations, the second type of training may involve training of multiple encoders and a single decoder of multiple decoders such that the multiple encoders share latent in a FP and the multiple decoders share gradients in a BP.

In some implementations, the second type of training may involve training of multiple decoders and a single encoder of multiple encoders such that the multiple encoders share latent in a FP and the multiple decoders share gradients in a BP.

In some implementations, the second type of training may involve training of multiple encoders and multiple decoders such that the multiple encoders share latent in a FP and the multiple decoders share gradients in a BP.

In some implementations, the third type of training may include an encoder-first sequence of separate trainings such that one or more encoders are trained first and one or more decoders learn how to work with the trained one or more encoders.

In some implementations, the third type of training may include a decoder-first sequence of separate trainings such that one or more decoders are trained first and one or more encoders learn how to work with the trained one or more decoders.

In some implementations, the third type of training may include an encoder-first sequence of separate trainings involving a first entity that uses an encoder training a respective matched encoder-decoder pair and providing a dataset to a second entity that uses a decoder and trains the decoder with the dataset.

In some implementations, the third type of training may include an encoder-first training of multiple encoders and multiple decoders such that: (a) each of one or more first entities having the multiple encoders trains a respective two-sided AI/ML model to provide a respective dataset; and (b) one or more second entities having the multiple decoders receive a combination of datasets from the one or more first entities and train the multiple decoders with the combination of datasets.

In some implementations, the third type of training may include a decoder-first sequence of separate trainings involving a first entity that uses a decoder training a respective matched encoder-decoder pair and providing a dataset to a second entity that uses an encoder and trains the encoder with the dataset.

In some implementations, the third type of training may include a decoder-first training of multiple encoders and multiple decoders such that: (a) each of one or more first entities having the multiple decoders trains a respective two-sided AI/ML model to provide a respective dataset; and (b) one or more second entities having the multiple encoders receive a combination of datasets from the one or more first entities and train the multiple encoders with the combination of datasets.

In some implementations, in participating in training of the two-sided AI/ML model, process 1200 may involve processor 1112 participating in training of the two-sided AI/ML model with respect to at least one of image compression, CSI compression, and PAPR reduction.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
participating, by a processor of an apparatus, in training of a two-sided artificial intelligence (AI)/machine learning (ML) model; and
performing, by the processor, a wireless communication by utilizing the two-sided AI/ML model.

2. The method of claim 1, wherein the participating in training of the two-sided AI/ML model comprises participating in:
a first type of training involving training of an autoencoder at a single entity; or
a second type of training involving joint training of one or more encoders and one or more decoders at different entities; or
a third type of training involving a sequence of separate trainings of the one or more encoders and the one or more decoders at the different entities.

3. The method of claim 2, wherein the first type of training comprises a training stage in which the apparatus, as a training entity, trains a matched two-sided AI/ML model in a single training session and through individual forward pass (FP) and backpropagation (BP) loops.

4. The method of claim 3, wherein the first type of training further comprises an inference stage in which a non-training entity requests the training entity to provide corresponding encoder and decoder models and downloads a corresponding part of the two-sided AI/ML model.

5. The method of claim 2, wherein the second type of training comprises a training stage in which an encoder shares encoded information in a forward pass (FP) and a decoder shares gradient in a backpropagation (BP).

6. The method of claim 5, wherein the second type of training involves the apparatus, as a training entity, and a non-training entity being synchronized and sharing a shared dataset and performing gradient exchange and latent output exchange.

7. The method of claim 2, wherein the second type of training involves training of multiple encoders and a single decoder of multiple decoders such that the multiple encoders share latent in a forward pass (FP) and the multiple decoders share gradients in a backpropagation (BP).

8. The method of claim 2, wherein the second type of training involves training of multiple decoders and a single encoder of multiple encoders such that the multiple encoders share latent in a forward pass (FP) and the multiple decoders share gradients in a backpropagation (BP).

9. The method of claim 2, wherein the second type of training involves training of multiple encoders and multiple decoders such that the multiple encoders share latent in a forward pass (FP) and the multiple decoders share gradients in a backpropagation (BP).

10. The method of claim 2, wherein the third type of training comprises an encoder-first sequence of separate trainings such that one or more encoders are trained first and one or more decoders learn how to work with the trained one or more encoders.

11. The method of claim 2, wherein the third type of training comprises a decoder-first sequence of separate trainings such that one or more decoders are trained first and one or more encoders learn how to work with the trained one or more decoders.

12. The method of claim 2, wherein the third type of training comprises an encoder-first sequence of separate trainings involving a first entity that uses an encoder training a respective matched encoder-decoder pair and providing a dataset to a second entity that uses a decoder and trains the decoder with the dataset.

13. The method of claim 2, wherein the third type of training comprises an encoder-first training of multiple encoders and multiple decoders such that:
each of one or more first entities having the multiple encoders trains a respective two-sided AI/ML model to provide a respective dataset; and
one or more second entities having the multiple decoders receive a combination of datasets from the one or more first entities and train the multiple decoders with the combination of datasets.

14. The method of claim 2, wherein the third type of training comprises a decoder-first sequence of separate trainings involving a first entity that uses a decoder training a respective matched encoder-decoder pair and providing a dataset to a second entity that uses an encoder and trains the encoder with the dataset.

15. The method of claim 2, wherein the third type of training comprises a decoder-first training of multiple encoders and multiple decoders such that:
each of one or more first entities having the multiple decoders trains a respective two-sided AI/ML model to provide a respective dataset; and
one or more second entities having the multiple encoders receive a combination of datasets from the one or more first entities and train the multiple encoders with the combination of datasets.

16. The method of claim 1, wherein the participating in training of the two-sided AI/ML model comprises participating in training of the two-sided AI/ML model with respect to at least one of image compression, channel state information (CSI) compression, and peak-to-average-power ratio (PAPR) reduction.

17. An apparatus implementable in a user equipment (UE), comprising:
a transceiver configured to communicate wirelessly; and
a processor coupled to the transceiver and configured to perform operations comprising:
participating in training of a two-sided artificial intelligence (AI)/machine learning (ML) model; and
performing, via the transceiver, a wireless communication by utilizing the two-sided AI/ML model.

18. The apparatus of claim 17, wherein the participating in training of the two-sided AI/ML model comprises participating in:
a first type of training involving training of an autoencoder at a single entity; or
a second type of training involving joint training of one or more encoders and one or more decoders at different entities; or
a third type of training involving a sequence of separate trainings of the one or more encoders and the one or more decoders at the different entities.

19. The apparatus of claim 18, wherein the third type of training comprises either:
an encoder-first sequence of separate trainings such that one or more encoders are trained first and one or more decoders learn how to work with the trained one or more encoders; or
a decoder-first sequence of separate trainings such that the one or more decoders are trained first and the one or more encoders learn how to work with the trained one or more decoders.

20. The apparatus of claim 17, wherein the participating in training of the two-sided AI/ML model comprises participating in training of the two-sided AI/ML model with respect to at least one of image compression, channel state information (CSI) compression, and peak-to-average-power ratio (PAPR) reduction.
